(19) United States
(12) Patent Application Publication
(10) Pub. No.: US 2007/0189761 A1
(43) Pub. Date: Aug. 16, 2007

(54) Implementing ic mounted sensor with high attenutation backing

(76) Inventor: Wojtek Sudol, Andover, MA (US)

Correspondence Address: PHILIPS INTELLECTUAL PROPERTY & STANDARDS, P.O. BOX 3001, BRIARCLIFF MANOR, NY, 10510, US

(21) Appl. No.: 10/596,181

(22) PCT Filed: Dec. 1, 2004
(86) PCT No.: PCT/IB04/52626

§ 371 Date: Jun. 2, 2006

Related U.S. Application Data
(60) Provisional application No. 60/527,013, filed on Dec. 4, 2003.

(51) Int. Cl. G03B 17/24

(52) U.S. Cl. 396/316

(57) ABSTRACT

According to an embodiment of the present disclosure, an ultrasound transducer probe (80) includes an attenuation backing substrate (94), an integrated circuit (88), and an array of piezoelectric elements (84). The integrated circuit (88) couples to the attenuation backing substrate (94), the integrated circuit (88) being translucent to acoustic waves. The array of piezoelectric elements (84) couples to the integrated circuit (88); the array of piezoelectric elements (84) having an acoustic matching layer disposed on a first surface of the array thereof.

The present disclosure generally relates to transducer arrays for use in medical ultrasound, and more particularly, to a method and apparatus for implementing an IC mounted sensor with a high attenuation backing.

In medical ultrasound, state of the art transducers are generally built on the surface of an integrated circuit (IC). The acoustic elements of the transducers are attached and individually electrically connected to a surface the IC. Typical technology used to accomplish that is flip chip. The IC provides electrical control of the elements, such as, for beam forming, signal amplifying, etc.

One example of a typical design of an ultrasound transducer is illustrated in FIG. 1. The ultrasound transducer 10 includes a flat array of acoustic elements 12 that are coupled to a surface of an integrated circuit 14 via flip-chip conductive bumps 16. A flip-chip underfill material 18 is included within a region between the flip-chip conductive bumps 16, the integrated circuit 14 and the flat array of acoustic elements 12. Transducer 10 further includes a transducer base 20 and an interconnection cable 22. Interconnection cable 22 is for interconnecting between the integrated circuit 14 and an external cable (not shown). Integrated circuit 14 is electrically coupled to the interconnection cable 22 via wirebonded wires 24, using techniques known in the art.

A disadvantage of the flip-chip approach is the effect of the IC on the acoustic attenuation of the transducer. During operation of the transducer, some of the acoustic energy generated by the piezoelectric element is directed in the desired direction of operation of the device. The remaining energy is directed in the opposite direction. In a typical ultrasound transducer, an acoustically absorbing backing is used to absorb this unwanted energy. However, with respect to IC mounted sensors, this has not been possible due to the location of the IC behind the acoustic elements.

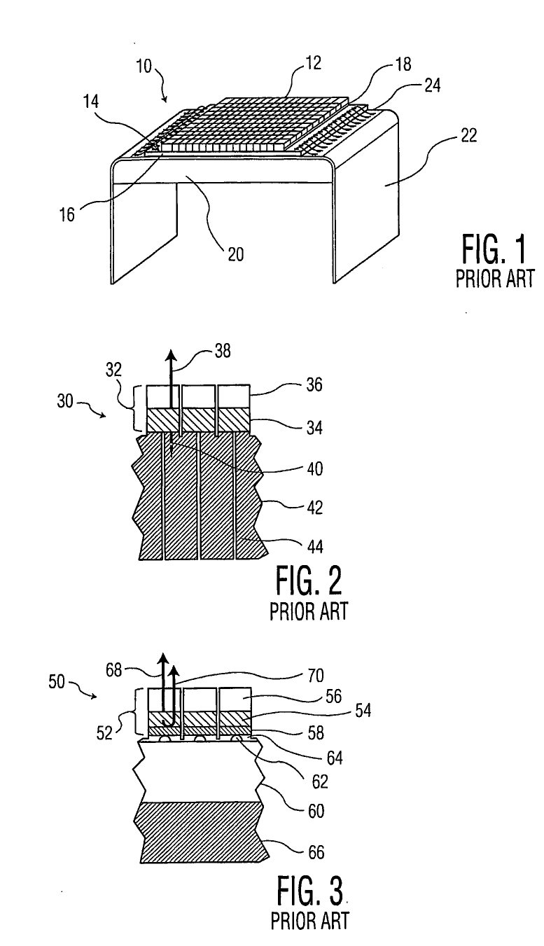

FIG. 2 shows a cross-section view of a portion of a typical ultrasound transducer 30. Ultrasound transducer 30 includes an array 32 of piezoelectric elements 34 and matching layer elements 36 coupled to corresponding piezoelectric elements. Acoustic energy generated by the piezoelectric element is indicated by reference numeral 38 and remaining energy directed in the opposite direction is indicated by reference numeral 40. The remaining energy 40 is attenuated by attenuating backing material 42. However, a disadvantage of this device is that attenuating backing material 42 includes electrical connections 44 to the individual piezoelectric elements 34 of the array 32. As a result, material 42 would include on the order of several thousands of electrical connections, for example, to be rendered within the same.

FIG. 3 is a cross-sectional view of a portion of another conventional ultrasound transducer 50. Ultrasound transducer 50 includes an array 52 of piezoelectric elements 54 and matching layer elements 56 coupled to corresponding piezoelectric elements. The ultrasound transducer 50 includes an acoustically reflective layer 58 positioned behind the piezoelectric resonator to decrease the need for an acoustic attenuator. Ultrasound transducer 50 also includes an integrated circuit 60, the integrated circuit being coupled to the array 52 via flip-chip electrical connections 62 and underfill material 64. Acoustic energy generated by a piezoelectric element is indicated by reference numeral 60 and remaining energy directed in the opposite direction is indicated by reference numeral 62, wherein the remaining energy 62 is reflected by acoustically reflective layer 58. This method however, makes fabrication of the transducer device very difficult.

Accordingly, an improved transducer probe and method for operating a transducer probe for overcoming the problems in the art is desired.

According to an embodiment of the present disclosure, an ultrasound transducer probe includes an attenuation backing substrate, an integrated circuit, and an array of piezoelectric elements, wherein the integrated circuit couples to the attenuation backing substrate and wherein the integrated circuit is translucent to acoustic waves. The array of piezoelectric and matching layer elements couples to the integrated circuit.

FIG. 1 is a plan view of a conventional ultrasound sensor;

FIG. 2 is a cross-sectional view of a conventional ultrasound sensor;

FIG. 3 is a cross-sectional view of another conventional ultrasound sensor;

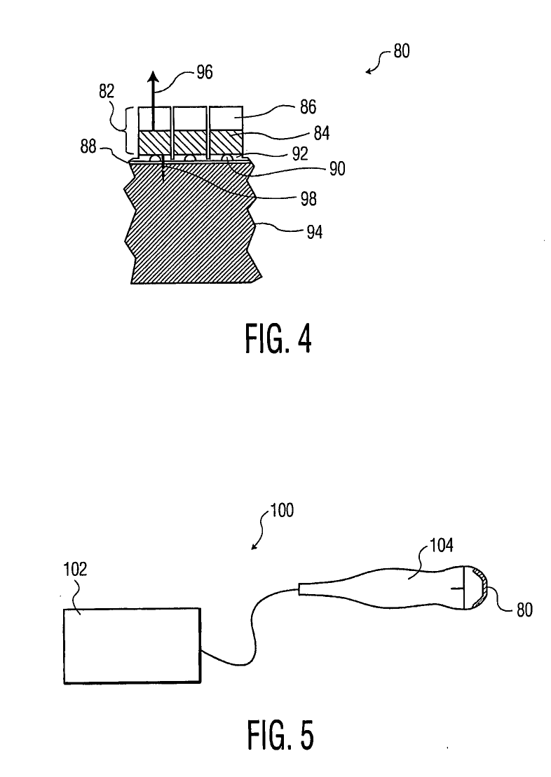

FIG. 4 is a cross-sectional view of a portion of an ultrasound transducer with an integrated circuit and acoustic attenuation in accordance with an embodiment of the present disclosure; and

FIG. 5 is a block diagram view of an ultrasound diagnostic imaging system with an ultrasound transducer according to an embodiment of the present disclosure.

FIG. 4 is a cross-sectional view of a portion of an ultrasound transducer 80 with an integrated circuit and acoustic attenuation in accordance with an embodiment of the present disclosure. Ultrasound transducer 80 includes an array 82 of piezoelectric elements 84 and matching layer elements 86 coupled to corresponding piezoelectric elements. The ultrasound transducer 80 also includes an integrated circuit 88, the integrated circuit being coupled to the array 82 via flip-chip electrical connections 90 and underfill material 92.

According to one embodiment, the integrated circuit 88 is substantially translucent to acoustic waves, wherein the IC thickness is made to be in the range of between 5-50 microns. The particular desired IC thickness also depends upon an intended ultrasound application. In one embodiment, a thickness of the integrated circuit is decreased by a mechanical grinding process, followed by chemical milling. Furthermore, the IC can include, for example, a silicon based IC.

In addition, transducer 80 includes attenuating backing material 94. Acoustic energy generated by a piezoelectric element is indicated by reference numeral 96 and remaining energy directed in the opposite direction is indicated by reference numeral 98. The remaining energy 98 passes through integrated circuit 88 and is attenuated by attenuating backing material 94.

FIG. 5 is a block diagram view of an ultrasound diagnostic imaging system with an ultrasound transducer according to an embodiment of the present disclosure. Ultrasound diagnostic imaging system 100 includes a base unit 102 adapted for use with ultrasound transducer probe 104. Ultrasound transducer probe 104 includes ultrasound transducer 80 as discussed herein. Base unit 102 includes additional conventional electronics for performing ultrasound diagnostic imaging. Ultrasound transducer probe 104 couples to base unit 102 via a suitable connection, for example, an electronic cable, a wireless connection, or other suitable means. Ultrasound diagnostic imaging system 100 can be used for performing various types of medical diagnostic ultrasound imaging.

According to one embodiment of the present disclosure, the ultrasound transducer provides a solution for implementing an IC mounted sensor with high attenuation backing. The IC thickness is made to be in the range of between 5-50 microns (depending on application), thereby causing the IC to become translucent to acoustic waves. As discussed, in one embodiment, a thickness of the integrated circuit (IC) can be decreased by a mechanical grinding process, followed by chemical milling. Additionally, an acoustically absorbing material that is positioned behind the thin layer of the IC material provides adequate attenuation.

An example of an application for the embodiments of the present disclosure includes a two-dimensional transducer. The embodiments of the present disclosure can also be advantageous in other IC mounted transducer designs. For example, in one-dimensional (1D) transducer applications, such as an intra-cardiac application, an IC can provide routing densities not achievable in conventional interconnection technologies, such as, printed circuit board (PCB), flex circuit, etc.

According to an embodiment of the present disclosure, an ultrasound transducer probe includes an attenuation backing substrate, an integrated circuit, and an array of piezoelectric elements. The integrated circuit couples to the attenuation backing substrate, wherein the integrated circuit is translucent to acoustic waves. The array of piezoelectric elements couple to the integrated circuit, wherein the array of piezoelectric elements have an acoustic matching layer disposed on a first surface of the array thereof.

The attenuation backing substrate can include any material capable of providing attenuation on the order of approximately 10 dB/cm (at 5 MHz) to 50 dB/cm (at 5 MHz). In addition, the attenuation backing substrate can include epoxy composite materials that consist of epoxy and a mixture of very high and very low acoustic impedance particles, having a thickness on the order of 0.125 inches.

In one embodiment, the ultrasound transducer probe includes an integrated circuit having a thickness sufficiently small for causing the integrated circuit to be translucent to acoustic waves. Still further, the thickness of the integrated circuit is on the order of approximately 5-50 μm. Still further, the integrated circuit includes at least one of a silicon based, a gallium based, and a germanium based integrated circuit. In addition, in one embodiment, the array of piezoelectric elements includes a two-dimensional array. In another embodiment, the array of piezoelectric elements includes a one-dimensional array.

In yet another embodiment, an ultrasound transducer probe includes an attenuation backing substrate, an integrated circuit coupled to the backing substrate, and an array of piezoelectric elements. The attenuation backing substrate includes a material capable of providing attenuation on the order of approximately 10 dB/cm at 5 MHz to 50 dB/cm at 5 Mhz. As discussed herein, in one embodiment, the integrated circuit is translucent to acoustic waves, wherein the integrated circuit includes a thickness on the order of approximately 5-50 μm and is sufficiently small for causing the integrated circuit to be translucent to acoustic waves. Still further, an array of piezoelectric elements couples to the integrated circuit; wherein the array of piezoelectric elements includes an acoustic matching layer disposed on a first surface of the array thereof.

In yet another embodiment, a method of fabricating an ultrasound transducer probe comprises providing an attenuation backing substrate. An integrated circuit couples to the attenuation backing substrate, wherein the integrated circuit is translucent to acoustic waves. In addition, an array of piezoelectric elements couples to the integrated circuit; the array of piezoelectric elements having an acoustic matching layer disposed on a first surface of the array thereof. For example, the attenuation backing substrate includes a material capable of providing attenuation on the order of approximately 10 dB/cm at 5 MHz to 50 dB/cm at 5 MHz.

According to one embodiment of the present disclosure, a method of making an ultrasound transducer probe includes providing an attenuation backing substrate, wherein the attenuation backing substrate includes a material capable of providing attenuation on the order of approximately 10 dB/cm at 5 MHz to 50 dB/cm at 5 MHz. An integrated circuit is coupled to the attenuation backing substrate, wherein the integrated circuit is translucent to acoustic waves and wherein the integrated circuit includes a thickness on the order of approximately 5-50 μm and is sufficiently small for causing the integrated circuit to be translucent to acoustic waves. Lastly, an array of piezoelectric elements couple to the integrated circuit, further wherein; the array of piezoelectric elements having an acoustic matching layer disposed on a first surface of the array thereof.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. An ultrasound transducer probe, comprising:
an attenuation backing substrate;
an integrated circuit coupled to the attenuation backing substrate, wherein the integrated circuit is translucent to acoustic waves; and
an array of piezoelectric elements coupled to the integrated circuit; the array of piezoelectric elements having an acoustic matching layer disposed on a first surface of the array thereof.

2. The ultrasound transducer probe of claim 1, wherein the attenuation backing substrate includes a material capable of providing an attenuation on the order of approximately 10 dB/cm at 5 MHz to 50 dB/cm at 5 MHz.

3. The ultrasound transducer probe of claim 1, wherein the attenuation backing substrate includes epoxy composite materials that consist of epoxy and a mixture of very high and very low acoustic impedance particles.

4. The ultrasound transducer probe of claim 1, wherein the integrated circuit includes a thickness sufficiently small for causing the integrated circuit to be translucent to acoustic waves.

5. The ultrasound transducer probe of claim 1, wherein the thickness of the integrated circuit is on the order of approximately 5-50 μm.

6. The ultrasound transducer probe of claim 1, wherein the integrated circuit includes at least one of a silicon based, a gallium based, and a germanium based integrated circuit.

7. The ultrasound transducer probe of claim 1, wherein the array of piezoelectric elements includes a two-dimensional array.

8. The ultrasound transducer probe of claim 1, wherein the array of piezoelectric elements includes a one-dimensional array.

9. An ultrasound transducer probe, comprising:
an attenuation backing substrate, wherein the attenuation backing substrate includes a material capable of providing an attenuation on the order of approximately 10 dB/cm at 5 MHz to 50 dB/cm at 5 Mhz;
an integrated circuit coupled to the attenuation backing substrate, wherein the integrated circuit is translucent to acoustic waves, wherein the integrated circuit includes a thickness on the order of approximately 5-50 μm and is sufficient for causing the integrated circuit to be translucent to acoustic waves; and
an array of piezoelectric elements coupled to the integrated circuit; the array of piezoelectric elements having an acoustic matching layer disposed on a first surface of the array thereof.

10. The ultrasound transducer probe of claim 9, wherein the attenuation backing substrate includes an epoxy composite material that consists of an epoxy and a mixture of very high and very low acoustic impedance particles, and wherein the integrated circuit includes a silicon based integrated circuit.

11. An ultrasound diagnostic imaging system utilizing an ultrasound transducer probe, the transducer probe comprising:
an attenuation backing substrate, wherein the attenuation backing substrate includes a material capable of providing an attenuation on the order of approximately 10 dB/cm at 5 MHz to 50 dB/cm at 5 MHz;
an integrated circuit coupled to the attenuation backing substrate, wherein the integrated circuit is translucent to acoustic waves, wherein the integrated circuit includes a thickness on, the order of approximately 5-50 μm and is sufficient for causing the integrated circuit to be translucent to acoustic waves; and
an array of piezoelectric elements coupled to the integrated circuit; the array of piezoelectric elements having an acoustic matching layer disposed on a first surface of the array thereof.

12. A method of fabricating an ultrasound transducer probe, comprising:
providing an attenuation backing substrate;
coupling an integrated circuit to the attenuation backing substrate, wherein the integrated circuit is translucent to acoustic waves; and
coupling an array of piezoelectric elements to the integrated circuit; the array of piezoelectric elements having an acoustic matching layer disposed on a first surface of the array thereof.

13. The method of claim 12, wherein the attenuation backing substrate includes a material capable of providing an attenuation on the order of approximately 10 dB/cm at 5 MHz to 50 dB/cm at 5 MHz.

14. The method of claim 12, wherein the attenuation backing substrate includes an epoxy composite material that consists of epoxy and a mixture of very high and very low acoustic impedance particles.

15. The method of claim 12, wherein the integrated circuit includes a thickness sufficiently small for causing the integrated circuit to be translucent to acoustic waves.

16. The method of claim 12, wherein the thickness of the integrated circuit is on the order of approximately 5-50 μm.

17. The method of claim 12, wherein the integrated circuit includes a silicon based integrated circuit.

18. The method of claim 1, wherein the array of piezoelectric elements includes a two-dimensional array.

19. The method of claim 1, wherein the array of piezoelectric elements includes a one-dimensional array.

20. A method of making an ultrasound transducer probe, comprising:
providing an attenuation backing substrate, wherein the attenuation backing substrate includes a material capable of providing an attenuation on the order of approximately 10 dB/cm at 5 MHz to 50 dB/cm at 5 MHz;
coupling an integrated circuit to the attenuation backing substrate, wherein the integrated circuit includes a thickness on the order of approximately 5-50 μm and is sufficiently small for causing the integrated circuit to be translucent to acoustic waves; and
coupling an array of piezoelectric elements coupled to the integrated circuit; the array of piezoelectric elements having an acoustic matching layer disposed on a first surface of the array thereof.
